(19) United States
(12) Patent Application Publication
(10) Pub. No.: US 2024/0116540 A1
(43) Pub. Date: Apr. 11, 2024

(54) Distributed Computing System For A Vehicle

(71) Applicant: Motional AD LLC, Boston, MA (US)

(72) Inventors: Ting Wang, Santa Monica, CA (US); Guillaume Binet, Pittsburgh, PA (US); Alejandro Olivares, Clariton, PA (US); Sammy Omari, Pittsburgh, PA (US)

(21) Appl. No.: 18/139,850

(22) Filed: Apr. 26, 2023

Related U.S. Application Data
(60) Provisional application No. 63/334,890, filed on Apr. 26, 2022.

(51) Int. Cl. B60W 60/00; H04N 23/698

(52) U.S. Cl. CPC B60W 60/0015; H04N 23/698; B60W 2420/403; B60W 2420/408; B60W 2556/00

(57) ABSTRACT

Provided are systems, methods, and computer program products for a distributed computing system for a vehicle. A vehicle (such as an autonomous vehicle) can have a hardware architecture including a master embedded system and multiple slave embedded systems. Each of the master and slave embedded systems can include, for example, a system on a chip (SoC). Each of the slave embedded systems can have multiple sensors of the vehicle assigned thereto, can process data generated by its assigned sensors, and can communicate an output of its processing to the master embedded system. The master embedded system can control timing of the slave embedded systems, such as by rotating sequentially through each of the slave embedded systems, such that timing of the sensors' data generating and processing can be controlled. Each of the slave embedded systems can communicate with the master embedded system via a high speed interface.

### CROSS-REFERENCE TO RELATED APPLICATIONS

The present application claims priority to U.S. Provisional Patent Appl. No. 63/334,890, filed Apr. 26, 2022, and incorporates herein by reference in their entireties the disclosure of the U.S. Non-Provisional Patent application with the Attorney Docket No.: 46154-0438001/12022068, titled “SCALABLE CONFIGURABLE CHIP ARCHITECTURE” filed on Apr. 26, 2023 and the U.S. Non-Provisional Patent application with the Attorney Docket No.: 46154-0445001/12022075, titled “DISTRIBUTED COMPUTING ARCHITECTURE WITH SHARED MEMORY FOR AUTONOMOUS ROBOTIC SYSTEMS” filed on Apr. 26, 2023.

### BACKGROUND

An autonomous vehicle is capable of sensing its surrounding environment and navigating without human input. Upon receiving data representing the environment and/or any other parameters, the vehicle performs processing of the data to determine its movement decisions, e.g., stop, move forward/reverse, turn, etc. The decisions are intended to safely navigate the vehicle along a selected path to avoid obstacles and react to a variety of scenarios, such as, presence, movements, etc. of other vehicles, pedestrians, and/or any other objects. Timely detection of objects and resolution of decisions is important to safe operation of the vehicle and/or its components.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIGS. 4C and 4D are a diagram illustrating example operation of a CNN;

FIG. 5A is a diagram of an implementation of a distributed computing system for a vehicle;

FIG. 5B is a diagram of another implementation of a distributed computing system for a vehicle;

FIG. 5C is a diagram of an implementation of sectors of a vehicle for the distributed computing system of FIG. 5B;

FIG. 5D is another diagram of the implementation of sectors of FIG. 5C;

FIG. 6 is a diagram of a process for the distributed computing system of FIG. 5B; and

FIG. 7 illustrates an example of a process for predicting agent importance for autonomous driving, according to some embodiments of the techniques discussed in the present disclosure.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

An autonomous robotic system, such as an autonomous vehicle (AV) compute, can have a hardware architecture including a master embedded system and multiple slave embedded systems. Each of the master and slave embedded systems can include, for example, a system on a chip (SoC). Each of the slave embedded systems can have multiple sensors (e.g., cameras, LiDAR sensors, radar sensors, etc.) of the vehicle assigned thereto, can process data generated by its assigned sensors, and can communicate an output of its processing to the master embedded system. The master embedded system can control timing of the slave embedded systems, such as by rotating sequentially through each of the slave embedded systems, such that timing of the sensors' data generation and processing can be controlled. Each of the slave embedded systems can communicate with the master embedded system via a high speed interface.

Some of the advantages of these techniques include allowing for distributed computing on board a vehicle, which may reduce power consumption and/or reduce cost. A master embedded system controlling synchronization of multiple slave embedded systems may provide low latency in data generation and processing. Each of the vehicle's sensors can be assigned to one of the slave embedded systems, which may improve control of the sensors' data generation by the master embedded system controlling timing of each of the slave embedded systems and/or may reduce delay in processing the sensors' generated data because each slave embedded system is only responsible for processing data from its assigned sensors and can begin processing such data without needing to wait for any other slave embedded system to process data generated by its assigned sensors. Each of the sensors assigned to a particular slave embedded system can be in a same physical sector of the vehicle, which may allow for efficient identification of which sensor is or should be assigned to a particular slave embedded system and/or efficient control of particular sensors by the master embedded system's synchronization control of the slave embedded system. Each of the slave embedded systems being able to communicate with the master embedded system via a high speed interface may allow data to be communicated without the delays incurred through use of a traditional IEEE 1588/gPTP (generalized Precision Time Protocol), e.g., by allowing for board-to-board communication.

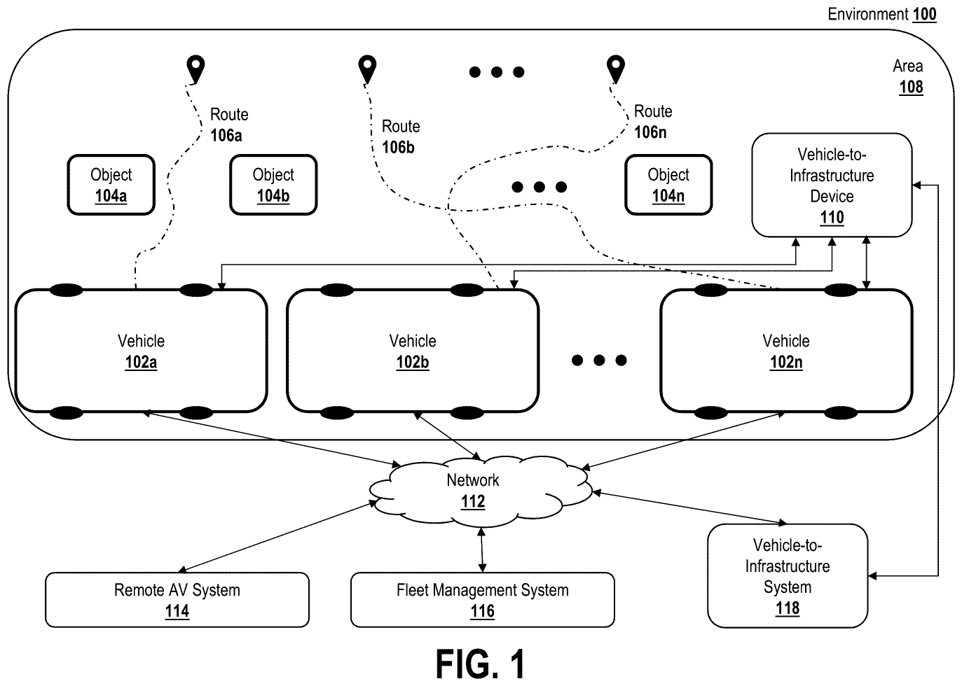

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

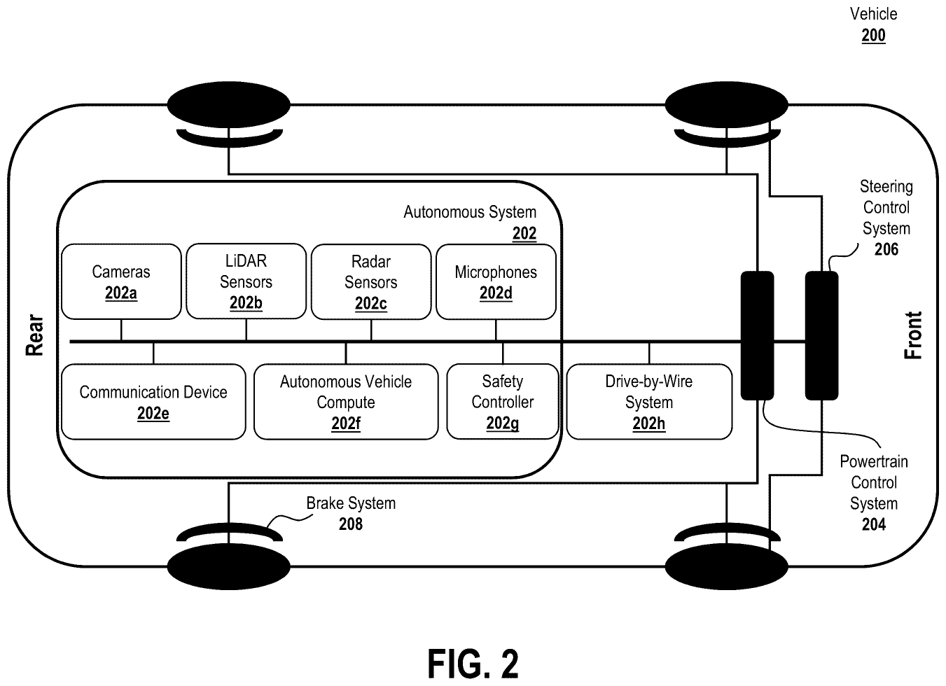

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g., a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicle 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

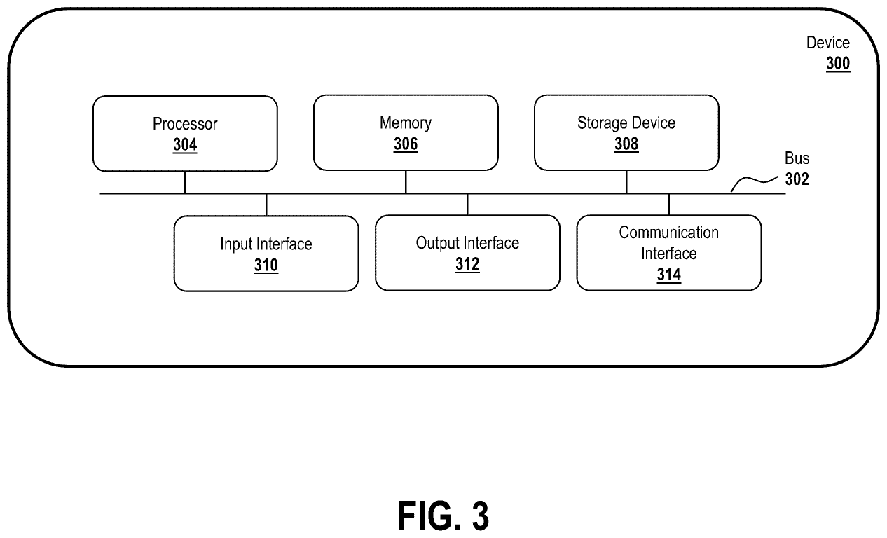

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, camera 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is configured to implement autonomous vehicle software 400, described herein. In an embodiment, autonomous vehicle compute 202f is the same or similar to distributed computing architecture. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of V2I device 110 (e.g., at least one device of a system of V2I device 110), at least one device of AV system 114 (e.g., at least one device of a system of AV system 114), at least one device of fleet management system 116 (e.g., at least one device of a system of fleet management system 116), at least one device of V2I system 118 (e.g., at least one device of a system of V2I system 118), at least one device of cameras 202a (e.g., at least one device of a system of cameras 202a), at least one device of LiDAR sensors 202b (e.g., at least one device of a system of LiDAR sensors 202b), at least one device of radar sensors 202c (e.g., at least one device of a system of radar sensors 202c), at least one device of microphones 202d (e.g., at least one device of a system of microphones 202d), at least one device of communication device 202e (e.g., at least one device of a system of communication device 202e), at least one device of autonomous vehicle compute 202f (e.g., at least one device of a system of autonomous vehicle compute 202f), at least one device of safety controller 202g (e.g., at least one device of a system of safety controller 202g), at least one device of DBW system 202h (e.g., at least one device of a system of DBW system 202h), at least one device of powertrain control system 204 (e.g., at least one device of a system of powertrain control system 204), at least one device of steering control system 206 (e.g., at least one device of a system of steering control system 206), at least one device of brake system 208 (e.g., at least one device of a system of brake system 208), at least one device of platform sensors (e.g., at least one device of a system of platform sensors), and/or one or more devices of network 112 (e.g., one or more devices of a system of network 112). In some embodiments, one or more devices of vehicles 102 (e.g., one or more devices of a system of vehicles 102), one or more devices of V2I device 110 (e.g., one or more devices of a system of V2I device 110), one or more devices of AV system 114 (e.g., one or more devices of a system of AV system 114), one or more devices of fleet management system 116 (e.g., one or more devices of a system of fleet management system 116), one or more devices of V2I system 118 (e.g., one or more devices of a system of V2I system 118), one or more devices of cameras 202a (e.g., one or more devices of a system of cameras 202a), one or more devices of LiDAR sensors 202b (e.g., one or more devices of a system of LiDAR sensors 202b), one or more devices of radar sensors 202c (e.g., one or more devices of a system of radar sensors 202c), one or more devices of microphones 202d (e.g., one or more devices of a system of microphones 202d), one or more devices of communication device 202e (e.g., one or more devices of a system of communication device 202e), one or more devices of autonomous vehicle compute 202f (e.g., one or more devices of a system of autonomous vehicle compute 202f), one or more devices of safety controller 202g (e.g., one or more devices of a system of safety controller 202g), one or more devices of DBW system 202h (e.g., one or more devices of a system of DBW system 202h), one or more devices of powertrain control system 204 (e.g., one or more devices of a system of powertrain control system 204), one or more devices of steering control system 206 (e.g., one or more devices of a system of steering control system 206), one or more devices of brake system 208 (e.g., one or more devices of a system of brake system 208), one or more devices of platform sensors (e.g., one or more devices of a system of platform sensors), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

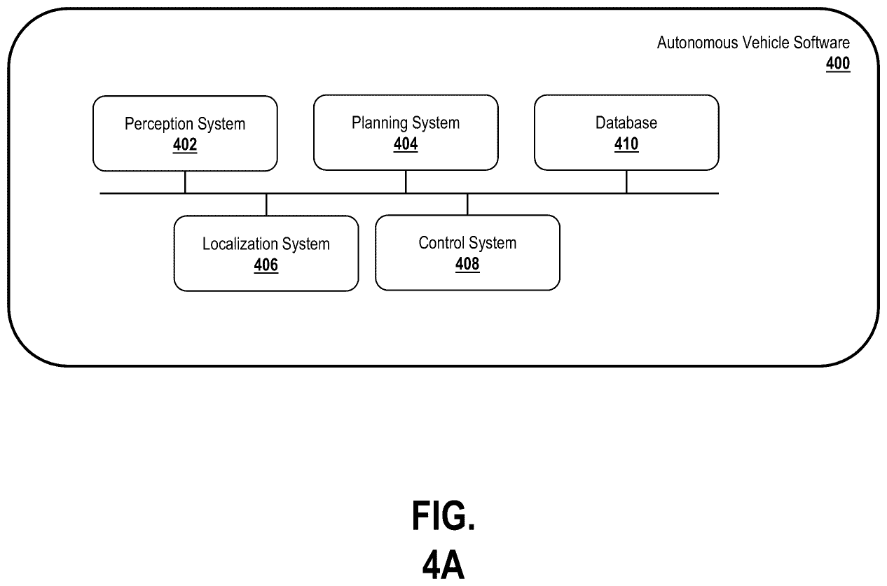

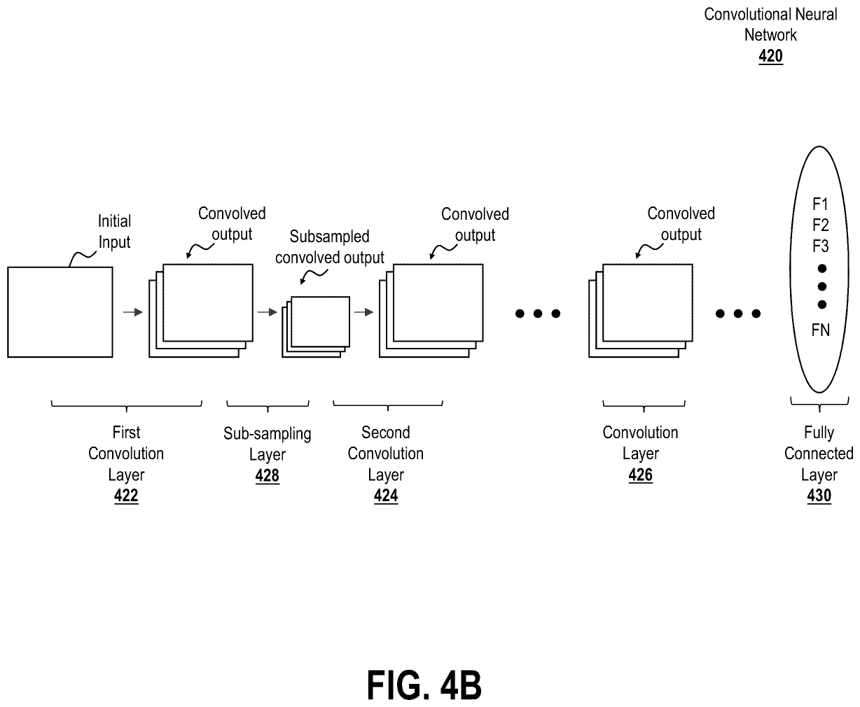

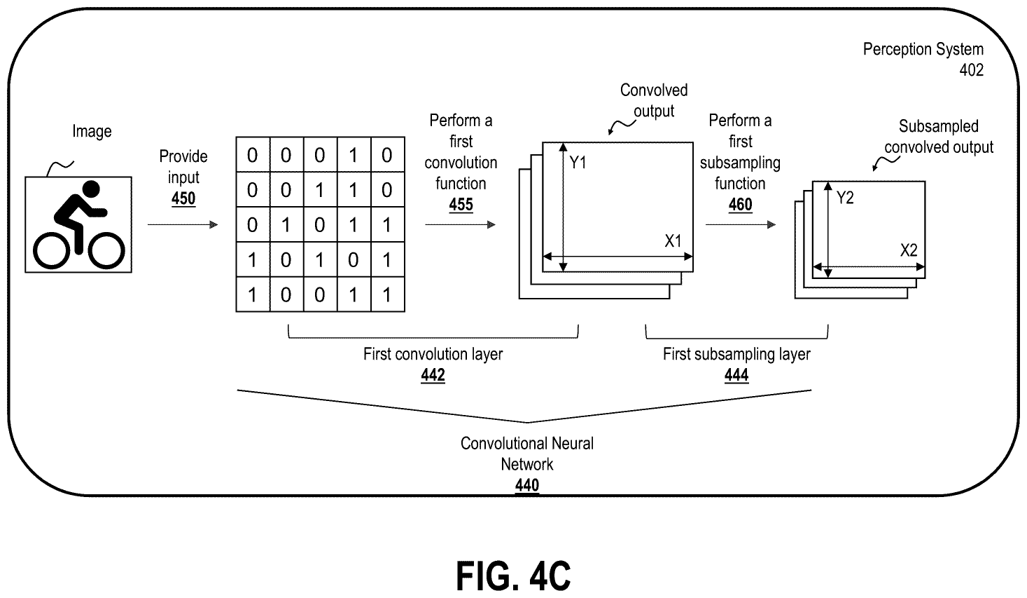

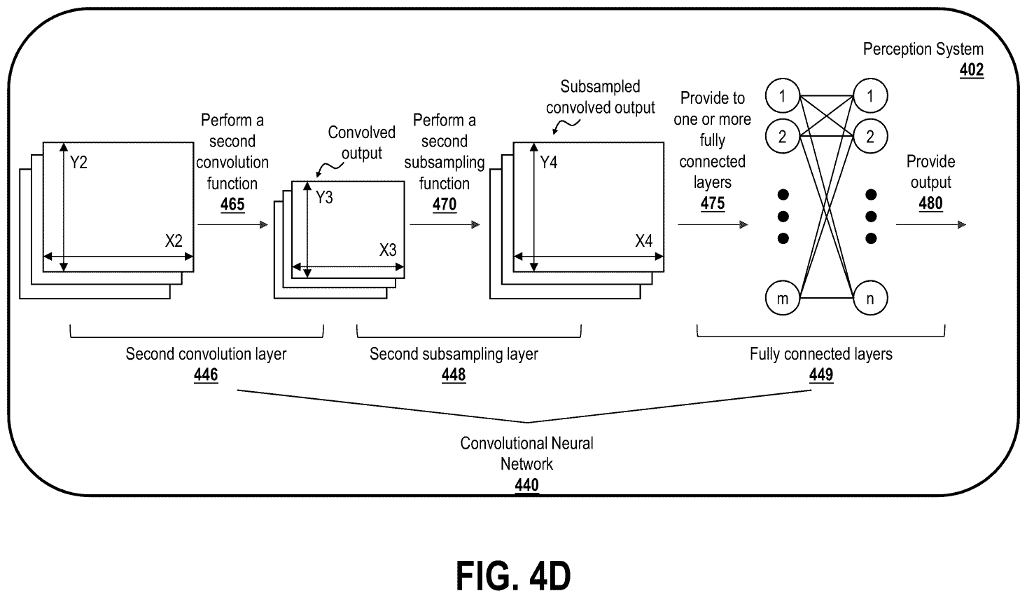

Referring now to FIGS. 4A-4D, illustrated is an example block diagram of an autonomous vehicle software 400 (sometimes referred to as an “AV stack”). As illustrated, autonomous vehicle software 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle software 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle software 400 are implemented, computer hardware (e.g., by microprocessors, microcontrollers, application-specific integrated circuits (ASICs), Field Programmable Gate Arrays (FPGAs), and/or the like), chiplets, or distributed computing architectures. It will also be understood that, in some embodiments, autonomous vehicle software 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle software 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

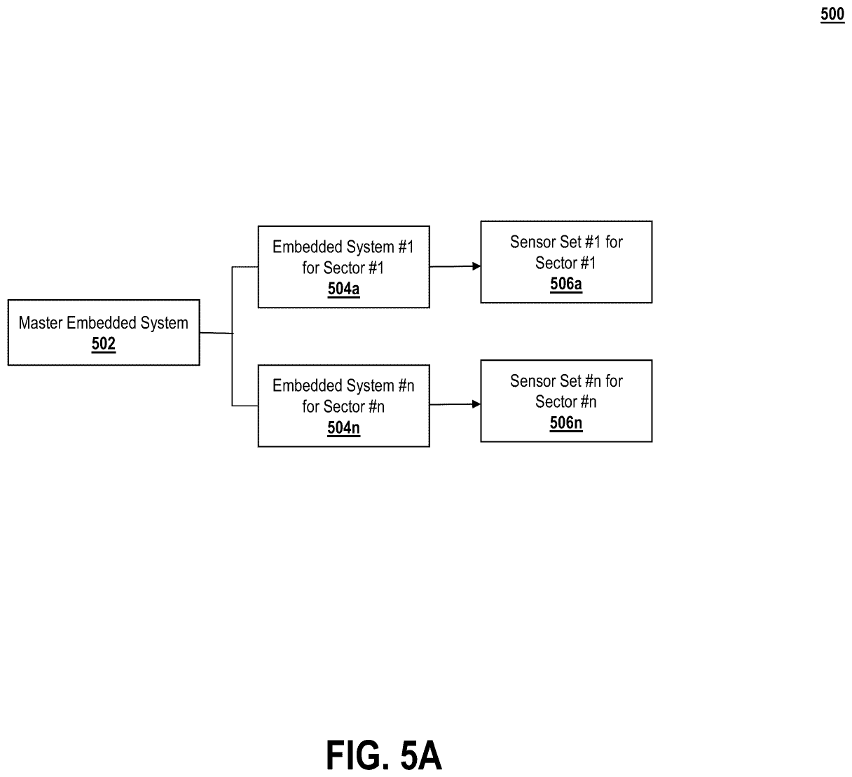

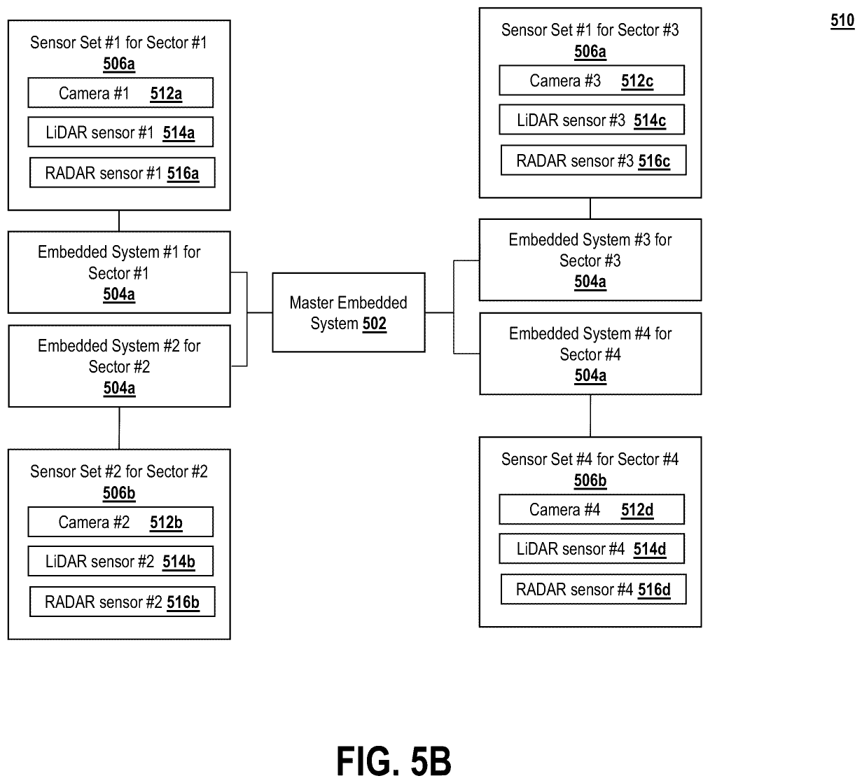

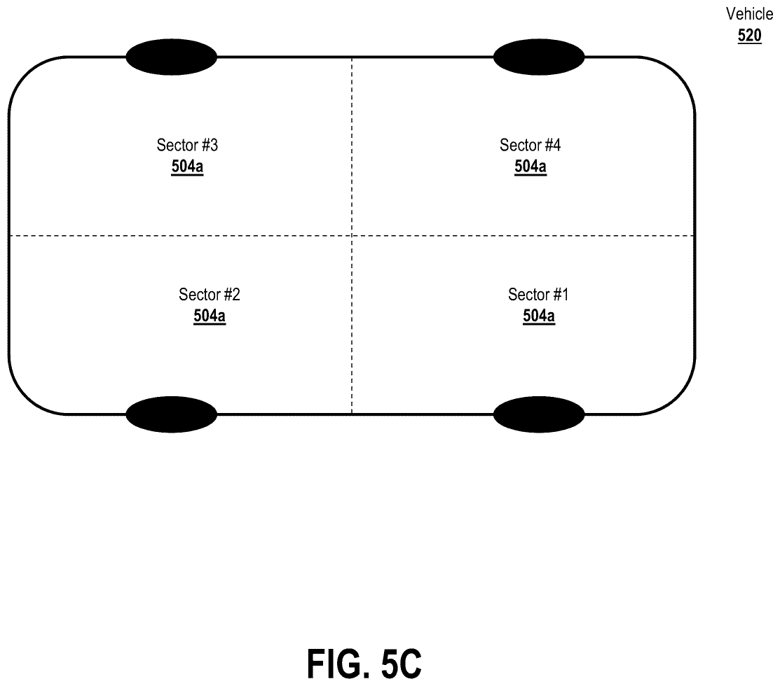

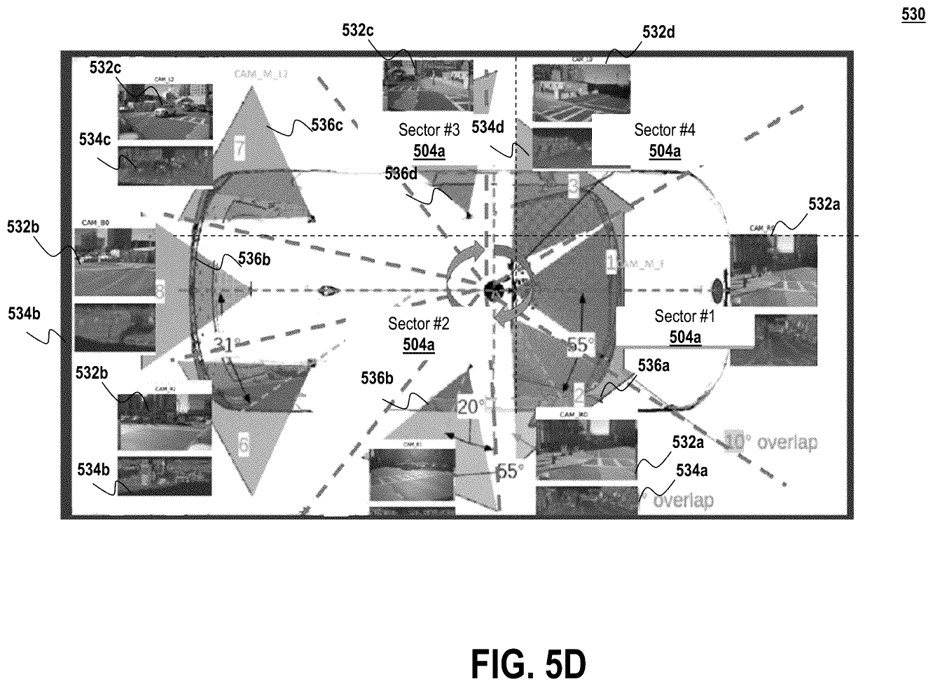

FIGS. 5A-5D illustrate examples of distributed computing systems for a vehicle, such as vehicles 102 described with reference to FIG. 1 and/or vehicle 400 described with reference to FIG. 4A. Referring now to FIG. 5A, illustrated is an example of a system 500 for distributed computing on board an autonomous robotic system, such as an autonomous vehicle (e.g., a vehicle that is the same as or similar to vehicles 102 and/or vehicle 200). The discussion of the system 500 refers to a vehicle (e.g., an AV) but similarly applies to other autonomous robotic systems.

The example system 500 includes a master embedded system 502 (also labeled in FIG. 5A as “embedded system #0), a plurality of slave embedded systems 504a to 504N (also labeled in FIG. 5A as “embedded system #2” to “embedded system #N”), and a plurality of sets of sensors 506a to 506N (also labeled in FIG. 5A as “sensor set #2” to “sensor set #N”). Each of the slave embedded systems 504a 504N can be configured to be in communication with the master embedded system 502. Each of the plurality of sets of sensors 506a to 506N can be configured to be in communication with one of the plurality of slave embedded systems 504a to 504N so as to be assigned to one of the slave embedded systems 504a to 504N. Within the example system 500, “N” represents an integer equal to or greater than two, e.g., 2, 3, 4, 5, 6, 7, 8, etc.

The master embedded system 502 can be configured to control or synchronize timing of the slave embedded systems 504a to 504N, such as by rotating sequentially through each of the slave embedded systems 504a to 504N so as to time operations performed by the slave embedded systems 504a to 504N. In some embodiments, the master embedded system's controlling or synchronizing of the timing can be based on rotation of at least one LiDAR sensor in the sets of sensors 506a to 506N.

Each of the slave embedded systems 504a to 504N can be configured to communicate with its associated one of the sets of sensors 506a to 506N, such that the timing of the sensors' data generation and data processing can be controlled by the master embedded system 502. For example, the master embedded system 502 can be configured to sequentially transmit a request to each of the slave embedded systems 504a to 504N requesting sensor data from the slave embedded system 504a to 504N, prompting each slave embedded system 504a to 504N to receive and process data from its associated set of sensors 506a to 506N. The processed data can be transmitted, by each slave embedded system 504a to 504N, as an output, to the master embedded system 502. The data processing performed by the slave embedded systems 504a to 504N can be similar to the data processing discussed with reference to FIG. 2.

In some embodiments, any of the master embedded system 502, the slave embedded systems 504a to 504N, and the sets of sensors 506a to 506N can be included in or coupled to an autonomous system, e.g., autonomous system 200 of FIG. 2. The master embedded system 502 and the slave embedded systems 504a to 504N can be coupled to or can be part of an autonomous vehicle compute, e.g., autonomous vehicle compute 202f of FIG. 2, of the autonomous system. The master embedded system 502 can be configured to communicate with a DBW system of the autonomous system, such as DBW system 202h of FIG. 2, to facilitate control of the vehicle by the DBW system based at least in part on data received from the master embedded system 502. In the embodiment of FIG. 2 as discussed above, each of the cameras 202a, LiDAR sensors 202b, radar sensors 202c, and microphones 202d is configured to be in communication with autonomous vehicle compute 202f.

In some embodiments, the vehicle can be divided into a plurality of sectors. The embodiment of FIG. 5A shows the sectors as sectors #1 to #N. In general, the sectors represent physical areas of the vehicle, in which the sensors of the sets of sensors 506a to 506N can be located (e.g., sensors of sensor set #1 being located in sector #1 and sensors of sensor set #N being located in sector #N). Each of the sets of sensors 506a to 506N can be configured to generate data in its associated sector #1 to #N of an environment 360° around the vehicle, and the sets of sensors 506a to 506N are configured to collectively sense the environment 360° around the vehicle. Each of the slave embedded systems 504a to 504N can be assigned to one of the sectors, as shown for example in FIG. 5A, in which embedded system #1 is assigned to sector #1 and embedded system #N is assigned to sector #N.

Each of the sets of sensors 506a to 506N includes a plurality of sensors. Examples of the sensors include a camera that is the same or similar to the camera 202a of FIG. 2, a LiDAR sensor that is the same or similar as the LiDAR sensor 202b of FIG. 2, a radar sensor that is the same or similar to the radar sensor 202c of FIG. 2, a microphone that is the same or similar to the microphone 202d of FIG. 2, or any other type of sensing devices. In some embodiments, each of the sensors in a set of sensors 506a to 506N is a different type of sensor. Including different sensor types may allow for each of the slave embedded systems 504a to 504N to be associated with only one sensor of a particular type (e.g., one camera, one LiDAR sensor, etc.), which may facilitate assigning the sensors to sectors (e.g., to respective slave embedded systems each associated with one sector), since a sensor of a particular type would not be assigned to a slave embedded system already including that particular type of sensor. In some embodiments, each of the sets of sensors 506a to 506N can includes an equal number of sensors. An even distribution of sensors among the slave embedded systems 504a to 504N may help balance processing over all of the slave embedded systems 504a to 504N since each slave embedded system 504a to 504N has a same number of sensors assigned thereto. In some embodiments, the sets of sensors 506a to 506N can include different numbers of sensors that are unevenly distributed among the slave embedded systems 504a to 504N.

In some embodiments, each of the sets of sensors 506a to 506N includes at least one radar sensor and at least one other type of sensor (e.g., at least one camera and/or at least one LiDAR sensor). Each of the slave embedded systems 504a to 504N can be configured to fuse the processed sensor data, including radar sensor data and at least one other type of sensor data, to provide an output of fused data to the master embedded system 502.

In some embodiments, the master embedded system 502 and the slave embedded systems 504a to 504N can be or can be part of an autonomous vehicle compute, such as the autonomous vehicle compute 202f. The sets of sensors 506a to 506N can each be configured to be in communication with their respectively associated slave embedded system 504a to 504N (e.g., sensor set #1 506a configured to be in communication with embedded system #1 504a and sensor set #N 506N configured to be in communication with embedded system #N 504N). In the example communication configuration, the sensors of the sets of sensors 506a to 506N do not communicate directly with the master embedded system 502 but instead they communicate directly with their associated slave embedded systems 504a to 504N. The data generated by the various sensors may be processed by various slave embedded systems 504a to 504N instead of being processed by a single device (e.g., by the master embedded system 502), which may allow for low latency in data generation and processing. In general, low latency may allow for better control of the vehicle since data may be more quickly generated and processed for use in controlling the vehicle (or, as mentioned above, another autonomous robotic system).

In some embodiments, each of the master embedded system 502 and slave embedded systems 504a to 504N can include a system-on-chip (SoC). A SoC refers to an integrated circuit (or a “chip”) that integrates all or most components of a computing system and/or other electronic systems. Such components include, for example, a central processing unit (CPU), input/output (I/O) devices, memory, storage, etc. Other components may include various communication components, graphics processing units (GPU), etc. The components may be integrated on a single substrate or microchip. Various digital, analog, mixed-signal, and/or radio frequency (RF) signal processing functions, etc. may be incorporated as well. A SoC can integrate a microcontroller, a microprocessor and/or one or more processor cores with a GPU, Wi-Fi and/or cellular network radio components, etc. Similar to how a microcontroller integrates a microprocessor with peripheral circuits and memory, a SoC can be seen as integrating a microcontroller with even more advanced peripherals.

In some embodiments, each of the slave embedded systems 504a to 504N can be configured to communicate with the master embedded system 502 via a high speed interface. Each of the slave embedded systems 504a to 504N being able to communicate with the master embedded system 502 via the high speed interface may allow data to be communicated without the delays incurred through use of a traditional generalized precision time protocol (e.g., IEEE 1588/gPTP). For example, with each of the master embedded system 502 and slave embedded systems 504a to 504N including an SoC, chip-to-chip or board-to-board communication can be achieved using the high speed interface, reducing the delays incurred through use of a traditional IEEE 1588/gPTP.

In some embodiments, the system 500 is scalable. The system 500 being scalable allows at least one slave embedded system to be added to the system 500 and/or at least one of the slave embedded systems 504a to 504N to be removed from the system 500. The system 500 being scalable may, for example, allow for an outdated or malfunctioning slave embedded system to be replaced with another slave embedded system and/or allow for each slave embedded system to be responsible for less data processing (e.g., because the number of slave embedded systems 504a to 504N in the system 500 increased) and thus may further reduce latency. In the event that a total number of slave embedded systems 504a to 504N of the system 500 changes (e.g., “N” changes from one integer value to another, different integer value due to the addition and/or removal of at least one slave embedded system), the sectors of the vehicle can be reassigned (e.g., by the master embedded system 502), to reflect the new number of slave embedded systems 504a to 504N (e.g., so the number of sectors equals “N”) The sensors in each of the sets of sensors 506a to 506N, and thus the sensors assigned to each of the slave embedded systems 504a to 504N may thus change as a result of the number of slave embedded systems 504a to 504N changing.

Referring now to FIG. 5B, illustrated is an example of a system 510 for distributed computing on board an autonomous robotic system, such as an autonomous vehicle (e.g., a vehicle that is the same as or similar to vehicles 102 and/or vehicle 200). The discussion of the system 510 refers to a vehicle (e.g., an AV) but similarly applies to other autonomous robotic systems.

The example system 510 of FIG. 5B illustrates an embodiment in which the number “N” of sectors of the vehicle of FIG. 5A equals four. The example system 510 includes a master embedded system 502 (also labeled in FIG. 5B as “embedded system #0”) that corresponds to master embedded system 502, four sectors (identified in FIG. 5B as “sector #1,” “sector #2,” “sector #3,” and “sector #4”), four slave embedded systems 504a, 504b, 504c, 504d (also labeled in FIG. 5B as “embedded system #1,” “embedded system #2,” “embedded system #3,” and “embedded system #4”) each configured to be in communication with the master embedded system 502 and that correspond to the slave embedded systems 504a to 504N, and four sets of sensors 506a, 506b, 506c, 506d (also labeled in FIG. 5B as “sensor set #1,” “sensor set #2,” “sensor set #3,” and “sensor set #4”) each configured to be in communication with one of the plurality of slave embedded systems 504a, 504b, 504c, 504d and that correspond to the sets of sensors 506a to 506N.

As illustrated in FIG. 5B, each of the sets of sensors 506a, 506b, 506c, 506d includes a same number of sensors, three in the embodiment, and a same type of sensors, camera 512a, 512b, 512c, 512d (e.g., a camera that is the same or similar as the camera 202a of FIG. 2), LiDAR sensor 514a, 514b, 514c, 514d (e.g., a LiDAR sensor that is the same or similar as the LiDAR sensor 202b of FIG. 2), and radar sensor 516a, 516b, 516c, 516d (e.g., a radar sensor that is the same or similar as the radar sensor 202c of FIG. 2) in the illustrated embodiment. Each of the sets of sensors 506a, 506b, 506c, 506d can include radar sensor 516a, 516b, 516c, 516d and two other types of sensor (camera 512a, 512b, 512c, 512d and LiDAR sensor 514a, 514b, 514c, 514d), which may provide earlier fusion and reduce latency as compared to traditional systems.

FIG. 5C illustrates an example vehicle 520 including four sectors #1, #2, #3, #4, such as the four sectors #1, #2, #3, #4 described with reference to FIG. 5B. The sectors #1, #2, #3, #4 in the illustrated embodiment represent a substantially equal physical area of the vehicle. In other embodiments, at least one of the sectors #1, #2, #3, #4 can represent a differently sized physical area of the vehicle than the other ones of the sectors #1, #2, #3, #4.

The example vehicle 520 has a slave embedded system 504a, 504b, 504c, 504d dedicated to each sector #1, #2, #3, #4, allowing for support of a non-uniform distribution of algorithms needed to process sensor data (e.g., data received at slave embedded system 504a, 504b, 504c, 504d from their respective sets of sensors 506a, 506b, 506c, 506d). One sector #1, #2, #3, #4 of a vehicle can have different processing needs than one of more of the other sectors #1, #2, #3, #4. For example, sets of sensors 506a, 506b, 506c, 506d at a front of the vehicle 520 (e.g., sensor set #4 506d for sector #4 and sensor set #1 506a for sector #1) can require very different processing to achieve safe and effective vehicle control than sets of sensors 506a, 506b, 506c, 506d at a rear of the vehicle 520 (e.g., sensor set #2 506b for sector #2 and sensor set #3 506c for sector #3). The slave embedded systems 504a, 504b, 504c, 504d associated with the front of the vehicle 520 (e.g., embedded system #4 504d for sector #4 and embedded system #1 504a for sector #1) can include (e.g., have stored on SoC memory) algorithms needed for processing sensor data gathered from the front of the vehicle 520 while the slave embedded systems 504a, 504b, 504c, 504d associated with the rear of the vehicle 520 (e.g., embedded system #2 504b for sector #2 and embedded system #3 504c for sector #3) can include algorithms needed for processing sensor data gathered from a rear of a vehicle. For another example, sensor types can vary to a very high degree between various physical areas of the vehicle 520. The slave embedded systems 504a, 504b, 504c, 504d can thus include (e.g., have stored on SoC memory) algorithms needed for processing the particular sensors in its associated set of sensors 506a, 506b, 506c, 506d and may thereby conserve memory and/or require less expensive SoC components because fewer algorithms need be stored at each individual slave embedded system 504a, 504b, 504c, 504d.

The distribution of sensors across sectors also enables redundancy both in operation of the slave embedded systems 504a, 504b, 504c, 504d as well as in operation of the sensors. For example, in case of failure of slave embedded system 504a, the sector sensors supported by slave embedded system 504a are recoupled to one or more of other slave embedded systems 504b, 504c, 504d without degrading the performance of a vehicle such as vehicle 102 or autonomous vehicle 200. Similarly, in case of failure of one or more sensors of sector #1, the sensors in other sectors #2, #3, #4 can support the operation of a vehicle. The slave embedded system 504a associated with the faulty sensor(s) can be reassigned to diagnostic tasks to recover the faulty sensor(s) or in case the sensor is unrecoverable, reassigned to support sensors of an alternate sector #2, #3, #4.

FIG. 5D illustrates an example of a system 530 for distributed computing on board of a vehicle that is similar to the system 510 of FIG. 5B by including four sectors (e.g., the sectors #1, #2, #3, #4 of FIG. 5C) each having one associated slave embedded system (e.g., one of slave embedded systems 504a, 504b, 504c, 504d of FIG. 5B or one of the slave embedded systems 504a to 504N of FIG. 5A). In the illustrated embodiments, each of the sets of sensors (e.g., sets of sensors 506a, 506b, 506c, 506d of FIG. 5B or sets of sensors 506a to 506N of FIG. 5A) is different than in the system 510 of FIG. 5B. The discussion of the example system 530 refers to a vehicle (e.g., an AV) but can similarly apply to other autonomous robotic systems.

FIG. 5D illustrates each of the four sectors #1, #2, #3, #4 along with examples of camera data 532a, 532b, 532c, 532d respectively generated by cameras and configured to be communicated to the associated one of the slave embedded systems, LiDAR data 534a, 534b, 534c, 534d respectively generated by LiDAR sensors and configured to be communicated to the associated one of the slave embedded systems, and radar data 536a, 536b, 536c, 536d respectively generated by radar sensors. FIG. 5D also illustrates a representation 528 of the synchronization performed by a master embedded system of the system 530 (e.g., the master embedded system 502 of FIG. 5B or the master embedded system 502 of FIG. 5A). In the illustrated embodiment, sector #1 is associated with two cameras, two LiDAR sensors, and one radar sensor; sector #2 is associated with three each of cameras, LiDAR sensors, and radar sensors; sector #3 is associated with three each of cameras, LiDAR sensors, and radar sensors; and sector #4 is associated with two each of cameras, LiDAR sensors, and radar sensors. In some embodiments, sets of sensors can overlap two sectors. As shown for example in FIG. 5D, a first set of sensors overlaps with sector #2 and sector #3, and a second set of sensors overlaps with sector #1 and sector #4. Thus, the first set of sensors is configured to transmit gathered data to each of the embedded system #2 and embedded system #3, and the second set of sensors is configured to transmit generated data to each of the embedded system #1 and embedded system #4. Even though FIG. 5D illustrates four sectors, any number of sectors could be controlled by the aster embedding system 502, such as six, eight, ten, twelve or any other integer number.

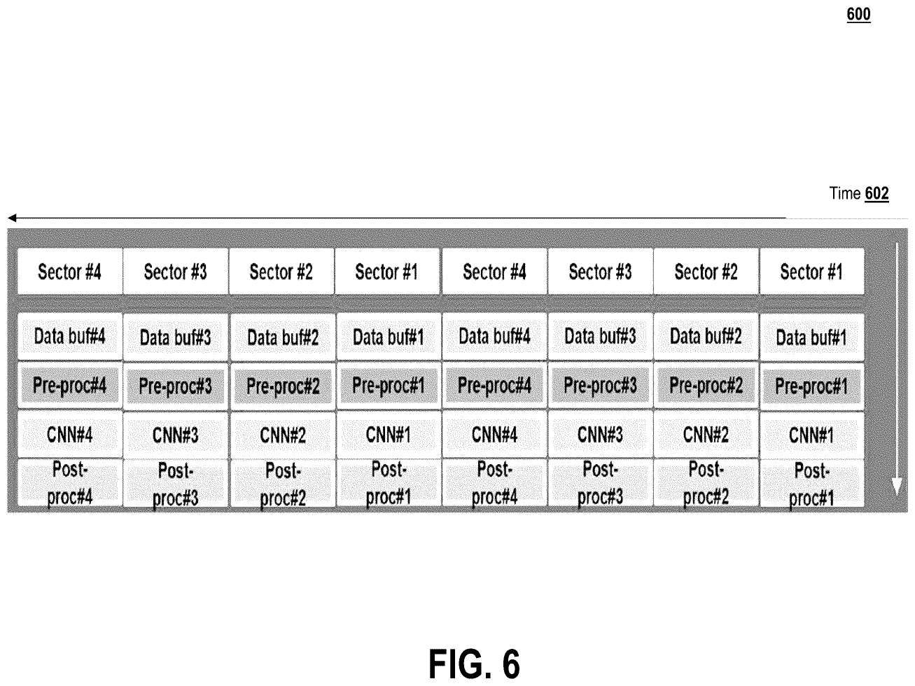

Referring now to FIG. 6, illustrated is an example of a flow demonstrating the synchronization of the example system 530 of FIG. 5D over time. As shown, data generation and processing begins at sector #1 and continues sequentially through sector #2, sector #3, and sector #4 before the series begins to repeat starting again with sector #1. FIG. 6 also illustrates an implementation of the data generation and processing that can be performed by each of the four slave embedded systems each associated with one of the sectors #1, #2, #3, #4. As illustrated, “data buff” represents data buffering (e.g., data received at the slave embedded system from its associated set of sensors). Data buffering can be followed by “pre-proc,” which represents the slave embedded system pre-processing the received sensor data. Pre-processing can be followed by “CNN,” which represents convolutional neural network processing such as that discussed with respect to FIG. 4D. CNN can be followed by “post-proc,” which represents final processing of the data. The slave embedded system is configured to transmit an output of the final processing to the master embedded system. The data generation and processing of one sector need not be finished, e.g., the slave embedded system may not have yet transmitted an output to the master embedded system, before the next sector begins its data generation and processing. Such timing may provide low latency in data generation and processing.

The process is shown in FIG. 6 as repeating only once, but the process can repeat any number of times. Additionally, the process may not end at a full cycle through all of the sectors, e.g., may not end at sector #4 as shown in FIG. 6.

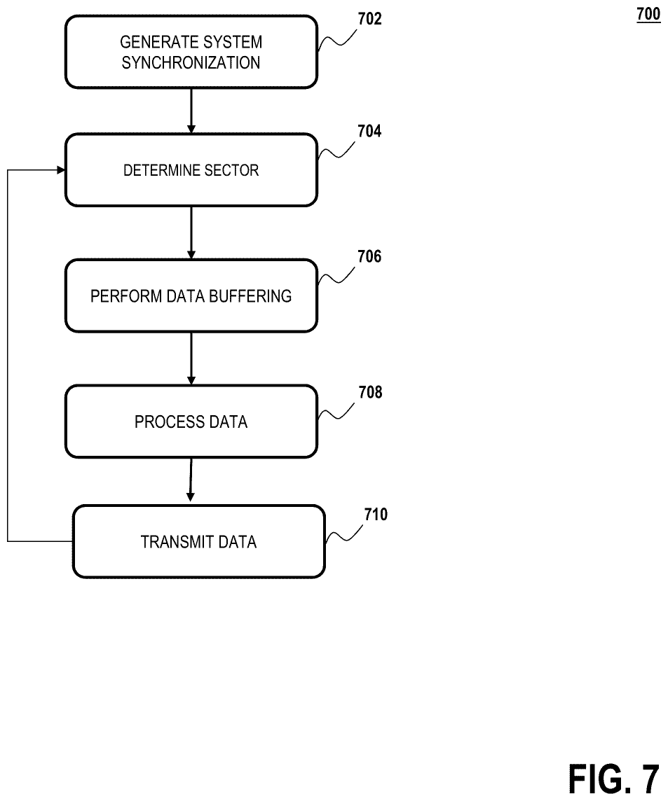

FIG. 7 illustrates an example monitoring process 700, according to some embodiments of the current subject matter. The process 700 may be executed by the example systems 100, 200, 300, 400, 500, 520, 530 shown in FIGS. 1-5D. For example, one or more of the operations described with respect to process 700 is performed (e.g., completely, partially, sequentially, non-sequentially, and/or the like) by the perception system 402, the planning system 404, and/or the control system 408 of the autonomous vehicle compute 400 of a vehicle (e.g., vehicle 102a, 102b, 102n described with reference to FIG. 1 or vehicle 200 described with reference to FIG. 2, or system 500 described with reference to FIG. 5A). Additionally, or alternatively, in some embodiments, one or more steps described with respect to the process 700 is performed (e.g., completely, partially, sequentially, non-sequentially, and/or the like) by another device or group of devices separate from or including the autonomous vehicle compute 400 and/or the example system 500.

At 702, a synchronization plan to be performed by a master embedded system of a system (e.g., example system 500, described with reference to FIG. 5A) is generated. The synchronization plan can include data to control or synchronize timing of multiple slave embedded systems corresponding to multiple sectors of the vehicle, such as by rotating sequentially through each of the slave embedded systems so as to time operations performed by the slave embedded systems. In some embodiments, the synchronization plan can include a sequence defining a cyclic order, in which slave embedded systems corresponding to multiple sectors are activated by the master embedded system. For example, the synchronization can include information for controlling timing of the sensors of respective the slave embedded systems for generating data that is used for the operation of the vehicle including an operation performed on one of a turn signal, headlights, door locks, windshield wipers, a powertrain control system, a steering control system, and a brake system. In some embodiments, if an additional slave embedded system is configured to be added to the autonomous system, the synchronization plan can be updated such that the additional slave embedded system is configured to be included in the cyclic execution schedule. The additional slave embedded system can be communicatively coupled to the master embedded system, such that the master embedded system can be configured to synchronize timing of the slave embedded systems and the additional slave embedded system. The sets of sensors can be configured to be reassigned after the addition of the additional slave embedded system such that each of the plurality of slave embedded systems and the additional slave embedded system has a set of sensors assigned thereto.

At 704, a sector of the vehicle is determined based on the synchronization plan and a timing for deactivation of a completed sector and activation of another (subsequent) sector. A slave embedded system of the determined sector can receive an activation trigger to perform processes that can be associated with an operation of at least one sensing device of a vehicle. The sensing device can include at least one of the following: a camera, a motion sensor, an image capturing device, a scanner, a keypad sensing device, a LiDAR, a radar, a microphone, an ultrasonic sensor, an inertial sensor, a GPS receiver, an odometry sensor, and any combination thereof, as described with reference to FIG. 2. For example, the sensing device can include at least one camera configured to detect optical light and generate image data associated with the environment external to the vehicle, at least one LiDAR sensor configured to detect light reflected from at least one object in the environment external to the vehicle and generate LiDAR data associated with the environment external to the vehicle, and at least one radar sensor configured to detect radio waves from at least one object in the environment external to the vehicle and generate radar data associated with the environment external to the vehicle. Each of the sets of sensors can be configured to generate data regarding the environment in a sector of the environment 360° around the vehicle; and the sets of sensors are configured to collectively sense the environment 360° around the vehicle

At 706, the data detected by the sensing devices of the slave embedded system of the determined sector is buffered. The slave embedded systems are configured to buffer and process the data received from its assigned set of sensors.

At 708, the buffered data is processed. The data processing can include pre-processing, prediction execution, and/or post-processing. The pre-processing can include a filter application (e.g., for data de-noising) to optimize the data processing and the result accuracy. The prediction execution can include providing the pre-processed data as an input to a machine learning model (e.g., CNN, as described with reference to FIG. 4D). For example, the prediction execution can include identifying one or more objects located in an environment and/or the like. The post-processing can include data aggregation based on event and/or agent type to optimize data transmission between the slave embedded system and the master embedded system.

At 710, results of the data processing are transmitted, by slave embedded system of the determined sector, to the master embedded system. The master embedded system can be configured to control an operation of the vehicle based on the received results of the data processing. An example of the vehicle operation can include a maneuver of the vehicle to ensure a safe movement of the vehicle along a set pathway.

According to some non-limiting embodiments or examples, provided is a vehicle, comprising: at least one computer-readable medium storing computer-executable instructions; a master embedded system configured to execute the computer executable instructions; a plurality of slave embedded systems each configured to execute the computer executable instructions and each communicatively coupled to the master embedded system, the master embedded system being configured to synchronize a timing of the plurality of slave embedded systems; and a plurality of sets of sensors, each of the sets of sensors being assigned to and communicatively coupled to one of the plurality of slave embedded systems, each of the sensors being configured to generate data regarding an environment external to a vehicle, and each of the sensors being configured to provide as an output the data to the one of the plurality of slave embedded systems to which the sensor is communicatively coupled; wherein each of the plurality of slave embedded systems is configured to process the data received from its assigned set of sensors and to transmit an output of data processing to the master embedded system.

According to some non-limiting embodiments or examples, provided is a method, comprising: generating, by each of a plurality of sets of sensors of a vehicle, generating data regarding an environment external to the vehicle; outputting, by each of the plurality of sets of sensors, outputting the generated data to an assigned one of a plurality of slave embedded systems of the vehicle; synchronizing a master embedded system of the vehicle synchronizing the timing of the plurality of slave embedded systems; and processing, by each of the plurality of slave embedded systems, processing the data received from its assigned set of sensors and transmitting an output of the processing to the master embedded system.

According to some non-limiting embodiments or examples, provided is at least one non-transitory computer-readable medium comprising one or more instructions that, when executed by at least one processor, cause the at least one processor to perform operations comprising: generating, by each of a plurality of sets of sensors of a vehicle, generating data regarding an environment external to the vehicle; outputting, by each of the plurality of sets of sensors, outputting the generated data to an assigned one of a plurality of slave embedded systems of the vehicle; synchronizing a master embedded system of the vehicle synchronizing the timing of the plurality of slave embedded systems; and processing, by each of the plurality of slave embedded systems, processing the data received from its assigned set of sensors and transmitting an output of the processing to the master embedded system.

Further non-limiting aspects or embodiments are set forth in the following numbered clauses:

Clause 1: A vehicle, comprising: at least one computer-readable medium storing computer-executable instructions; a master embedded system configured to execute the computer executable instructions; a plurality of slave embedded systems each configured to execute the computer executable instructions and each communicatively coupled to the master embedded system, the master embedded system being configured to synchronize a timing of the plurality of slave embedded systems; and a plurality of sets of sensors, each of the sets of sensors being assigned to and communicatively coupled to one of the plurality of slave embedded systems, each of the sensors being configured to generate data regarding an environment external to a vehicle, and each of the sensors being configured to provide as an output the data to the one of the plurality of slave embedded systems to which the sensor is communicatively coupled; wherein each of the plurality of slave embedded systems is configured to process the data received from its assigned set of sensors and to transmit an output of data processing to the master embedded system.

Clause 2: The vehicle of clause 1, wherein each of the sets of sensors comprises at least one camera configured to detect optical light and generate image data associated with the environment external to the vehicle, at least one LiDAR sensor configured to detect light reflected from at least one object in the environment external to the vehicle and generate LiDAR data associated with the environment external to the vehicle, and at least one radar sensor configured to detect radio waves from at least one object in the environment external to the vehicle and generate radar data associated with the environment external to the vehicle.

Clause 3: The vehicle of any of the preceding clauses, wherein each of the sets of sensors is configured to generate data regarding the environment in a sector of the environment 360° around the vehicle; and the sets of sensors are configured to collectively sense the environment 360° around the vehicle.

Clause 4: The vehicle of any of the preceding clauses, wherein the synchronization comprises controlling the timing for generating the data.

Clause 5: The vehicle of any of the preceding clauses, wherein the plurality of slave embedded systems are communicatively coupled to the master embedded system via a high speed interface.

Clause 6: The vehicle of any of the preceding clauses, further comprising an autonomous system comprising the master embedded system, the plurality of slave embedded systems, and the plurality of sets of sensors.

Clause 7: The vehicle of any of the preceding clauses, wherein the master embedded system is configured to transmit the output to a drive-by-wire system of the vehicle configured to generate, based at least in part on the output received from the master embedded system, a control signal configured to control at least one device of the vehicle.

Clause 8: The vehicle of any of the preceding clauses, wherein the at least one device comprises at least one of a turn signal, headlights, door locks, windshield wipers, a powertrain control system, a steering control system, and a brake system.

Clause 9: The vehicle of any of the preceding clauses, wherein each of the plurality of slave embedded systems is configured to process the data received from its assigned set of sensors; and the processing includes pre-processing of the data and post-processing of the data.

Clause 10: The vehicle of any of the preceding clauses, wherein at least one additional slave embedded system is configured to be added to the autonomous system such that the at least one additional slave embedded system is configured to execute the computer executable instructions and be communicatively coupled to the master embedded system, and such that the master embedded system being configured to synchronize the timing of the plurality of slave embedded systems and the at least one additional slave embedded system.

Clause 11: The vehicle of any of the preceding clauses wherein the plurality of sets of sensors are configured to be reassigned after the at least one additional slave embedded system is added, wherein each of the plurality of slave embedded systems and the at least one additional slave embedded system has a set of sensors assigned thereto.

Clause 12: A method, comprising: generating, by each of a plurality of sets of sensors of a vehicle, generating data regarding an environment external to the vehicle; outputting, by each of the plurality of sets of sensors, outputting the generated data to an assigned one of a plurality of slave embedded systems of the vehicle; synchronizing a master embedded system of the vehicle synchronizing the timing of the plurality of slave embedded systems; and processing, by each of the plurality of slave embedded systems, processing the data received from its assigned set of sensors and transmitting an output of the processing to the master embedded system.

Clause 13: A non-transitory computer-readable storage medium comprising at least one program for execution by at least one processor of a first device, the at least one program including instructions which, when executed by the at least one processor, cause the first device to perform the method of clause 12.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A vehicle, comprising:
at least one computer-readable medium storing computer-executable instructions;
a master embedded system configured to execute the computer executable instructions;
a plurality of slave embedded systems each configured to execute the computer executable instructions and each communicatively coupled to the master embedded system, the master embedded system being configured to synchronize a timing of the plurality of slave embedded systems; and
a plurality of sets of sensors, each of the sets of sensors being assigned to and communicatively coupled to one of the plurality of slave embedded systems, each of the sensors being configured to generate data regarding an environment external to a vehicle, and each of the sensors being configured to provide as an output the data to the one of the plurality of slave embedded systems to which the sensor is communicatively coupled;
wherein each of the plurality of slave embedded systems is configured to process the data received from its assigned set of sensors and to transmit an output of data processing to the master embedded system.

2. The vehicle of claim 1, wherein each of the sets of sensors comprises at least one camera configured to detect optical light and generate image data associated with the environment external to the vehicle,
at least one LiDAR sensor configured to detect light reflected from at least one object in the environment external to the vehicle and generate LiDAR data associated with the environment external to the vehicle, and
at least one radar sensor configured to detect radio waves from at least one object in the environment external to the vehicle and generate radar data associated with the environment external to the vehicle.

3. The vehicle of claim 1, wherein each of the sets of sensors is configured to generate data regarding the environment in a sector of the environment 360° around the vehicle; and
the sets of sensors are configured to collectively sense the environment 360° around the vehicle.

4. The vehicle of claim 1, wherein the synchronization comprises controlling the timing for generating the data.

5. The vehicle of claim 1, wherein the plurality of slave embedded systems are communicatively coupled to the master embedded system via a high speed interface.

6. The vehicle of claim 1, further comprising an autonomous system comprising the master embedded system, the plurality of slave embedded systems, and the plurality of sets of sensors.

7. The vehicle of claim 6, wherein the master embedded system is configured to transmit the output to a drive-by-wire system of the vehicle configured to generate, based at least in part on the output received from the master embedded system, a control signal configured to control at least one device of the vehicle.

8. The vehicle of claim 7, wherein the at least one device comprises at least one of a turn signal, headlights, door locks, windshield wipers, a powertrain control system, a steering control system, and a brake system.

9. The vehicle of claim 1, wherein each of the plurality of slave embedded systems is configured to process the data received from its assigned set of sensors; and
the processing includes pre-processing of the data and post-processing of the data.

10. The vehicle of claim 1, wherein at least one additional slave embedded system is configured to be added to the autonomous system such that the at least one additional slave embedded system is configured to execute the computer executable instructions and be communicatively coupled to the master embedded system, and such that the master embedded system being configured to synchronize the timing of the plurality of slave embedded systems and the at least one additional slave embedded system.

11. The vehicle of claim 10, wherein the plurality of sets of sensors are configured to be reassigned after the at least one additional slave embedded system is added, wherein each of the plurality of slave embedded systems and the at least one additional slave embedded system has a set of sensors assigned thereto.

12. A method, comprising:
generating, by each of a plurality of sets of sensors of a vehicle, data regarding an environment external to the vehicle;
outputting, by each of the plurality of sets of sensors, the data to an assigned one of a plurality of slave embedded systems of the vehicle;
synchronizing a master embedded system of the vehicle the timing of the plurality of slave embedded systems; and
processing, by each of the plurality of slave embedded systems, the data received from its assigned set of sensors and transmitting an output of the processing to the master embedded system.

13. A non-transitory computer-readable storage medium comprising at least one program for execution by at least one processor of a first device, the at least one program including instructions which, when executed by the at least one processor, cause the first device to perform operations comprising:
generating, by each of a plurality of sets of sensors of a vehicle, data regarding an environment external to the vehicle;
outputting, by each of the plurality of sets of sensors, the data to an assigned one of a plurality of slave embedded systems of the vehicle;
synchronizing a master embedded system of the vehicle the timing of the plurality of slave embedded systems; and
processing, by each of the plurality of slave embedded systems, the data received from its assigned set of sensors and transmitting an output of the processing to the master embedded system.
